(19) United States
(12) Patent Application Publication
(10) Pub. No.: US 2014/0337448 A1
(43) Pub. Date: Nov. 13, 2014

(54) SYSTEM AND METHOD FOR AGGREGATING AND RESPONDING TO COMMUNICATIONS

(71) Applicant: DISCONNECT ME NOW LLC, Clarkston, MI (US)

(72) Inventors: Mitchell A. Kline, Clarkston, MI (US); Jane M. Kline, Clarkston, MI (US); Evan J. Kline, Clarkston, MI (US); Brett A. Kline, Clarkston, MI (US)

(21) Appl. No.: 14/339,886

(22) Filed: Jul. 24, 2014

Related U.S. Application Data
(63) Continuation of application No. PCT/US2013/022730, filed on Jan. 23, 2013.
(60) Provisional application No. 61/590,572, filed on Jan. 25, 2012.

(51) Int. Cl. H04L 12/58

(52) U.S. Cl. CPC H04L 51/02
USPC 709/206

(57) ABSTRACT

The present application is directed to a method of aggregating and responding to communications. The method includes receiving incoming communications from a plurality of network connected communication sources, and automatically receiving, at a computing device, incoming communications from a plurality of network connected communication sources; and automatically sending to each of the plurality of network connected communication sources a customized message that is based on at least identification information associated with a sender of the respective incoming communication.

### CROSS-REFERENCE TO RELATED APPLICATIONS

The present application is a continuation of International Application No. PCT/US2013/022730, filed on Jan. 23, 2013, which claims priority to and the benefit of U.S. Provisional Patent Application No. 61/590,572, filed Jan. 25, 2012, the entire disclosure of each of which is incorporated herein by reference.

### BACKGROUND

There has been a dramatic increase in communication formats used by individuals in recent years. As a consequence, users must respond to and keep track of text messages, e-mail, fax, voice mail, phone calls, video messages, file transfer protocol messages, outlook updates, and a multitude of social media messages such as those sent via Skype, Twitter, Facebook, LinkedIn, and YouTube, for example.

One problem faced by individuals who receive messages from such a variety of sources is that such messages or communications are not aggregated into a common interface such that a user or computer program may view, organize, or respond to the various messages. Additionally, individuals that receive messages from such a variety of sources must regularly respond to these messages by logging in to each of the communication sources separately. In many cases, such individuals will forget to check certain communication sources or will be unable to respond the various messages in a timely fashion. Furthermore, if an individual desires to set aside a period of time for vacation, studying, etc., it is impractical to set “away messages” (i.e., automatic responses to the sender) for each of the various communication formats to inform people sending the communications they are temporarily unavailable.

It would be advantageous to provide a system and method that includes a common interface for aggregated communications formats that allows a user or computer program to perform various actions based on the aggregated communication formats. It would also be advantageous to provide a system and method for establishing a hierarchy of responses to be provided to users from a variety of sources depending on any of a variety of factors.

### SUMMARY

According to one exemplary embodiment, a method of aggregating and responding to communications includes the steps of receiving incoming communications from a variety of multiple format network connected communication sources and automatically sending to each of the plurality of network connected communication sources a customized message that is based on at least identification information associated with a sender of the respective incoming communication.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description and the drawing.

FIG. 1 is a schematic diagram of a network environment comprising a client-server architecture that is used to collect, aggregate and distribute communications according to one embodiment;

FIG. 2 is an example of a user interface included in the hierarchy of a website or displayed in association with a software program according to one embodiment;

FIG. 3 is a general flow chart of a process for aggregating multi-format communications and providing an automatic response to an incoming communication according to one embodiment; and

FIG. 4 is an example of a user interface displaying a prioritized list of messages displayed in association with a software program according to one embodiment.

FIG. 5a depicts a graphical user interface having a quick disconnect button according to one embodiment.

FIG. 5b depicts a graphical user interface having a quick connect button according to one embodiment.

FIG. 6 depicts a graphical user interface of a communication aggregation program CAP for setting disconnection modes in accordance with an illustrative embodiment.

FIG. 7 depicts a settings interface of a CAP in accordance with an illustrative embodiment.

FIG. 8 depicts a media selection interface of a CAP in accordance with an illustrative embodiment.

FIG. 9 depicts a time selection interface of a CAP in accordance with an illustrative embodiment.

FIG. 10 depicts a contact selection interface of a CAP in accordance with an illustrative embodiment.

FIG. 11 depicts a group contact selection interface of a CAP in accordance with an illustrative embodiment.

FIG. 12 depicts a message review interface of a CAP in accordance with an illustrative embodiment.

### DETAILED DESCRIPTION

Before describing in detail the particular improved system and method, it should be observed that the invention includes, but is not limited to a novel structural combination of data processing components and communications networks, and not in the particular detailed configurations thereof. Accordingly, the structure, methods, functions, control and arrangement of components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams.

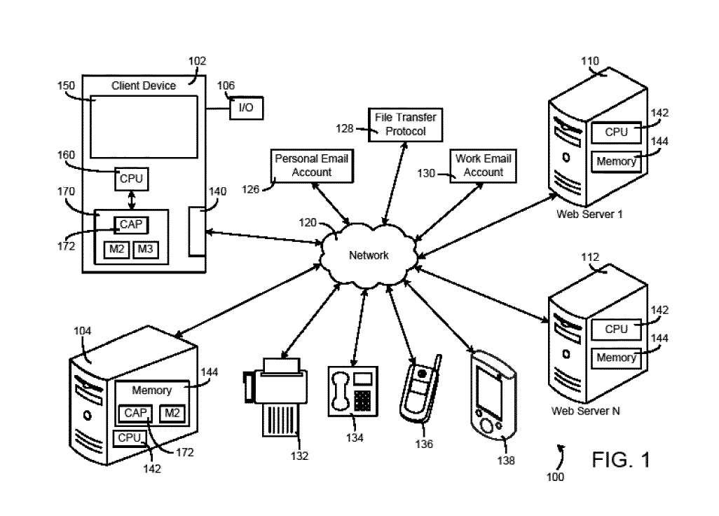

Referring to FIG. 1, a schematic diagram of a network environment 100 comprising a client-server architecture is shown. Client device 102 and web server 104 may have stored in memory a communication aggregation program (CAP) that when executed by a processor, identifies aspects of communications received at various network connected communication sources 110, 112, 126, 128, 130, 132, 134, 136, and 138 to provide automatic responsive communications based on the identified aspects of the incoming communications. According to one embodiment, web server 104 is a web server that hosts a website that executes processes associated with the CAP to collect, aggregate and distribute multi-format communications directed to a specified user. Client devices 102 may include desktop computers, smart phones, personal digital assistants (PDA), mainframes, minicomputers, personal computers, laptops, tablets, or any other computing device. Accordingly, various embodiments described herein relate to multi-platform message management system to aggregate communications from a variety of communication sources.

Client devices 102 may include a processing circuit 160, a memory 170, a network interface 140, a user input element 106 as well as a display 150, according to one exemplary embodiment. Client device 102 may be used to view a webpage stored on a web server such as web server 104, for example, using a software browser application. According to one embodiment, the display 150 may also be used by a user to view and interact with graphical user interfaces associated with software programs stored in memory 170 on client device 102. Each client device connected with network 120, such as client device 102, can communicate with computing devices such as other client devices, email accounts 126 and 130, and servers 104, 110 and 112 through one or more networks represented by element 120. Network element 120 can include a local area network (LAN), wide area network (WAN), a telephone network, such as the Public Switched Telephone Network (PSTN), a wireless link, an intranet, the internet, or combinations thereof.

Client devices 102 are also capable of being connected to the network 120 through a network interface 140. Servers 104, 110 and 112 are computing devices having a processor 142 and a memory 144. Processor 142 may include digital and/or analog electrical components (e.g., a microprocessor, application-specific integrated circuit, microcontroller, or other digital logic) configured to perform the functions described herein. Processor 142 may be a single server computer or a plurality of server computers, and may operate in a cloud computing environment, such as a shared, scalable computing environment. Memory 144 includes storage media, which may be volatile or non-volatile memory that includes, for example, read only memory (ROM), random access memory (RAM), magnetic disk storage media, optical storage media, flash memory devices and zip drives. Memory 144 may store data files associated with particular websites or user interfaces in a database format.

Each network connected communication source 110, 112, 126, 128, 130, 132, 134, 136 and 138 may facilitate transmission and reception of communications to a client device 102 or a web server 104. Additionally, each communication source may transmit and receive communications that include identification data related to the time of transmission or reception, the sender or recipient, or the format of the communication source. For example, servers 104, 110, and 112 may be associated with a particular website or user interface, such as a social media website, that allows registered website users to communicate with one another. These communications may be stored in servers 104, 110, and 112 and may contain information about the registered users, such as whether the sender of the communication is an established connection, whether the sender is a work colleague, friend or family member, or other identification data. In another embodiment, servers 104, 110, and 112 may be associated with any type of user interface such as an application on a smartphone, tablet, or other computing device.

Each of the communication sources shown in FIG. 1 such as work email accounts 130, personal email accounts 126, fax machines 132, mobile devices 136 and 138, servers associated with a particular website 110 and 112, telephone land lines 134, and file transfer protocol (FTP) messages 128 may be collected by the CAP stored in memory module 170 on a client device 102 or stored in memory on 144 on a web server 104.

For example, client device 102 may be a smart phone that includes software applications associated with each of the communication sources shown in FIG. 1. Each software application may receive and store communications sent to the various communication sources locally on client device 102. According to one embodiment, the CAP stored in at least one memory module 172 within memory 170 may access each of the software applications stored on client device 102 to retrieve communications received from network connected communication sources 110, 112, 126, 128, 130, 132, 134, 136 and 138, for example. According to another exemplary embodiment, the CAP may also access the multi-format communications directly from each individual network connected communications source shown in FIG. 1. In some cases, direct access to communication sources such as a server associated with a particular website 110 or 112 may be password protected or are otherwise restricted and may require an initial grant of access by a user. According to one exemplary embodiment, the CAP may broadcast the initial grant of user access to all network connected communication sources that share a common password.

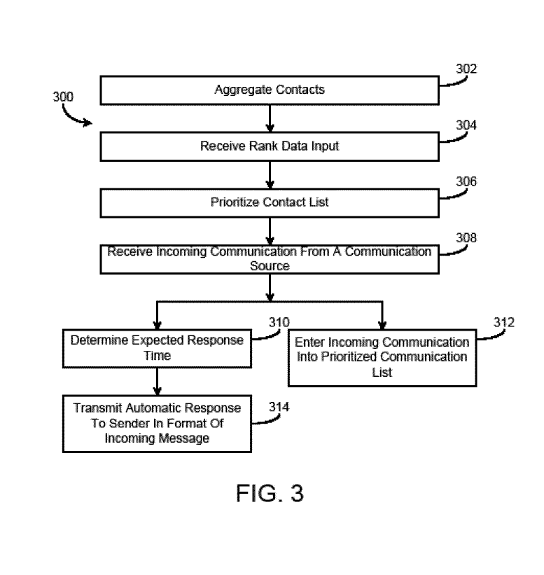

Referring now to FIG. 3, the CAP stored in memory 172 may carry out process 300 through a browser executable code that is executed on a server 104. In this embodiment, a user may access a first website using client device 102 so that display data from the webpage is displayed in a browser on a display 150 of client device 102. Alternatively, process 300 may also be carried out by a local processor 160 on a client device 102. For example, process 300 may be performed on a software application of a smartphone or other computing device. At step 302, process 300 may compile a list of contacts from each network connected communication source 110, 112, 126, 128, 130, 132, 134, 136, and 138, according to an embodiment. For example, web server 110 may be a server associated with a social media website and may have a list of contacts such as registered users associated with an end user, such as the user of the CAP. The CAP may automatically, or in response to input from the user, import the list of social media website registered users associated with the end user and store them in the CAP accessible memory of client device 102 or web server 104 at step 302. Furthermore, the CAP may continue this process for all accessible network connected communication sources, such that all contacts associated with the user of the CAP in each of the various communication sources depicted in FIG. 1 are collected and stored in local memory 170 or 144 at step 302.

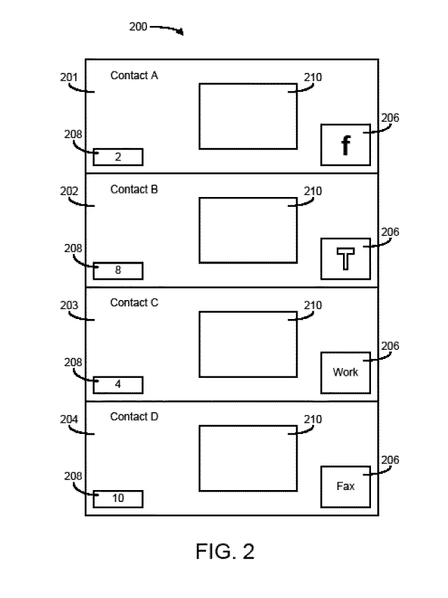

At step 302 of process 300, the CAP may assemble an aggregate contact list from collected contacts. One example of an aggregate contact list 200 is shown in FIG. 2. The aggregate contact list 200 may include all contacts collected by the CAP as well as contact data stored on client device 102 and contact data manually entered by a user through input/output device 106, for example. User input element 106 may comprise one or more user interface elements to receive an indication of user input including audio, mechanical, visual, motion, or other input. Referring again to FIG. 3, updates to the aggregate contact list 200 may be performed automatically by the CAP at step 302 on a periodic basis, manually as the result of a user input, or both.

During a CAP update, additional data may be added to a previously entered contact. For example, a user may have manually entered a name and number for contact in the aggregate contact list. During an update, the CAP may access all available communication sources to import additional contacts that have not yet been added to the aggregate contact list 200. The importation process may determine if a name or other identification data in the previously entered contact list matches with the identification data of potential contacts. According to one exemplary embodiment, the matching process compares individual stored data fields such as name, phone number or home address. The CAP may further determine the sender of a communication matches a contact if a predetermined degree of character similarity is identified. The matching process may use software algorithms, look-up tables, word parsing, and stop-wording techniques to identify the predetermined degree of character similarity. For example, the CAP may access data stored on the social media web server 110 at step 302 of process 300 to provide additional contact details such as home town, email address, birthday, mutual contacts, etc., to a previously entered contact that matches the sender of a communication stored at web server 110.

At step 304, a user may manually assign rankings to contacts A-D as shown in FIG. 2. Once a communication is received from a contact that has been manually ranked by a user, these manually assigned rankings may be used to determine the content of an automatic response to the received communication sent out by the CAP, or may further determine the order of a prioritized list of incoming messages displayed to a user on a graphical user interface 150, for example. The manually assigned contact rankings may be entered by the user of a client device 102 that has the CAP stored in local memory 172. The manually assigned rankings may also be entered on client device 102 that is accessing a website running the CAP stored on a web server memory 172. According to one embodiment, client device 102 accesses a website running the CAP using a browser software application that enables a graphical user interface to be displayed on display 150. In both cases, the rankings may be entered with an input/output device 106.

According to one embodiment, the user manually assigned rankings may be a character such as a number, for example, a number from 1-10. The user may also assign a number or ranking to a group of contacts rather than individual contacts. For example, the user may assign a 1 to all individuals/contacts classified as “work” contacts and a 5 to individuals/contacts classified as “family” contacts. As such, the individuals/contacts will be ranked based on a group with which they are affiliated. These classifications may be performed manually by the user or may be performed automatically by the CAP through retrieval of identification data contained in a work email address, the subject matter of a communication, or a communication source. For example, automatic CAP classifications may use a character recognition process to determine keywords indicating high priority individuals, by recognizing a company name in an email address. In addition, a number ranking may be assigned to the type of communication source. For example, all incoming communications received from a first social media website may be assigned a 1, all incoming communications received from a second social media website may be assigned a 6, while all faxes may be assigned a 9. In addition, a default ranking may be set for all contacts for which rankings are not otherwise modified.

At step 306, the aggregate contact list may be further prioritized based on rank data for the contacts. In an embodiment, step 306 may include prioritization based on a prioritization algorithm associated with the CAP. The prioritization algorithm may take various factors such as manual contact rankings, the type of format the communication is sent in such as telephone, fax, email, text message, etc., the relationship of the contact to the user or any other identification data that can be extracted from an incoming communication or other data source to determine a new aggregate contact list order or prioritization ranking for the contacts.

According to one embodiment, manually assigned rankings can be received at step 304 in graphical user interface element 208 as shown in FIG. 2. Group contact rankings and other multiple contact rankings may be entered into a separate graphical user interface element on a main menu, according to an embodiment. Additionally, graphical elements 206 and 210 may aid the user in manually assigning rankings. For example, graphical element 206 may include a description, logo from a social media website, image or other indication of a communication source the contact data was derived from. Graphical element 210 may include all available contact data manually entered by a user or collected from various communication sources 126, 128, 130, 132, 134, 138, 136, 110, and 112 such as name, address, telephone number, fax number, mutual contacts, and any personal notes entered by the user for example. Accordingly, each contact segment 201-204 may include multiple graphical elements if contact data 210 was assembled from multiple communication sources.

At step 308, the ranked list and/or prioritized list may be used to automatically respond to various incoming communications received from communication sources 126, 128, 130, 132, 134, 138, 136, 110, and 112. If the sender of the incoming communication is a previously stored contact, the automatic response sent at step 314 may include a personalized message directed to the sender or may update data associated with the contact. If the sender of the incoming communication is not a contact, the CAP may add the sender to the prioritized contact list assembled at step 306. In addition, a user may define settings in the CAP such that the CAP transmits a generic response at step 314 or ignores for incoming communications from sources that are not associated with a contact. Furthermore, according to one embodiment, once an incoming communication is received at step 308, process 300 may perform at least two processes in response. Process 300 provides an automatic response to the sender of the incoming communication at step 314 and also places the incoming communication into a prioritized communication list according to a CAP prioritization algorithm at step 312. These two processes and additional responses are optional and may be performed in parallel, series, and in any order in response to receiving an incoming communication at step 308. In an alternative embodiment, an automatic response may be transmitted to the sender of the incoming communication in step 314 directly after receiving the incoming communication in step 308, without performing step 310 or 312.

One purpose of the automatic response is to provide the sender of the communication with an indication of when they can expect a response from a user. This expected response time is based on multiple data inputs and is included in the automatic response. According to one embodiment, the expected response time determined at step 310 is based on the ranking assigned to the sender of the incoming communication, the number of messages received by the user in a predetermined time frame, whether the user has indicated they are currently accepting incoming communications, or other various factors. For example, to determine if the user has indicated they are accepting incoming communications, the CAP may determine if the user has an away message or meeting in a scheduling application such as Microsoft Outlook, for example. At step 310, process 300 may also determine if the user has otherwise indicated a period of time that the user is unavailable for communication. For example, if the user of client device 102 has indicated they will be unavailable for a period of 24 hours to study for a final exam in an software application such as Outlook or directly in the CAP application, step 310 will use this period of time to determine an expected response time. In addition, although the user may indicate a period of unavailability, senders, such as user selected contacts, may be able to override the period of unavailability in the case of emergency or if the sender is a contact designated by the user as someone who may contact the user during a period of unavailability, such as a spouse. For example, the automatic response transmitted at step 314 may include an option for the sender to indicate the emergency nature of a communication to increase the level of priority assigned to the communication. According to another embodiment, the user may communicate an emergency code to selected contacts online or offline to override a period of unavailability.

Furthermore, the CAP may automatically respond to the incoming message at step 314 in the same format as the incoming message. The automatic response may include an expected response time indicating when the user will be available to respond and any desired message to the sender. In an embodiment, the user may select, create, or modify the desired message, and the desired message may be common to multiple contacts or may be customized for individual of small groups of contacts. The automatic response time may be determined at step 310 using timestamp data associated with the incoming message as well as the time the automatic response is transmitted. For example, if the incoming message is received from a first social media website, the automatic reply may be sent to the senders inbox on the first social media website at step 314 and may be customized to include data such as “Hello [sender], [user] is unavailable for the next 8 hours to study for a final exam” in the case where the automatic response is sent 16 hours into the 24 hour period of unavailability. Although the automatic response sent to the social media website is in text, the automatic response may also be sent as a computer generated voice if the incoming message received at step 308 was a phone call from communication source 134, 136, or 138, for example. According to one embodiment, the automatic response may be sent as the recorded voice of a person other than a user, such as a celebrity, downloaded to client device 102 from a network connected source. Furthermore, in addition to a computer generated voice, the CAP may accept a recorded voice at I/O device 106, which may be a microphone or other recording device, for example.

The expected response time determined at step 310 may also be based on additional factors other than a user entered period of unavailability. For example, the expected response time may be increased or decreased depending on other factors such as the user assigned contact ranking received at step 304, the prioritized aggregate contact list determined at step 306, or the number of messages received in the prioritized communication list over a predetermined period of time. For example, if an initial expected response time is determined to be 8 hours based solely on user indicated availability, step 310 may increase the expected response time to 10 hours if the sender of the incoming communication being responded to has been ranked a 3 or lower. Additionally, if the prioritized communication list has received a number of incoming messages within a specified period of time that exceeds a predetermined threshold, such as more than 20 incoming messages in the last 24 hours, the CAP may increase the expected response time to 10 hours, for example. According to another embodiment, the CAP may determine how many messages a user receives over a predetermined period of time. If the number of communications over that predetermined period of time exceeds the average, the CAP may recalculate an expected response time. Accordingly, each incoming communication may receive a different response depending on the sender of the communication, the priority previously assigned to the sender of the communication, and the number of total messages received. Although step 310 of process 300 may alter the expected response time according to a predetermined algorithm, algorithm settings may be changed by manual user input to place more or less emphasis on the various data input used to determine the expected response time.

The prioritized communication list, as stated above, contains a listing of all received communications from the various communication sources 126, 128, 130, 132, 134, 138, 136, 110, and 112 as shown in FIG. 1 during a time period in which the user was unavailable. One example of a prioritized communication list 400 is shown in FIG. 4. The prioritized communication list 400 may be displayed as a graphical user interface to a user of client device 102 in display 150, for example. According to one exemplary embodiment, the prioritized list of communications 401-404 are listed in order such that communications near the top of the list are more likely to be of interest to the user of the CAP. For example, the CAP may first determine the identity of the sender and look up a previously entered ranking assigned by a user for that sender. If the sender has a high priority, the communication will be given a higher priority in the prioritized communication list, resulting in a more prominent list position such as position 401 or 402. If the sender has a low priority, they will be sent to a lower position on the prioritized list, such as position 404, for example. The list may be based on multiple factors other than a previously entered ranking assigned by a user. For example, the CAP may assign priority based on the time the message is received, the format the message is received in such as email or telephone call, or a group the sender is assigned to, such as family, an organization, or communication source, or any other desired priority factor. For user convenience, data used by the CAP to assign priority or other data may be displayed to the user in the prioritized communication list 400. For example, the time the communication was received 408, the source of the communication 406, the content of the communication 410, and the sender of the incoming communication 412 may all be displayed as shown in FIG. 4. Additionally, graphical element 412 may also include the automatic response sent at step 314 of process 300 for user reference.

According to one embodiment, once a user logs on to the CAP application on a client device 102, the user may be shown a prioritized list of messages on display 150, determined at step 306 of process 300. The user may choose to sort the order of the default prioritized list in multiple ways including based on the user assigned contact ranking, the importance of message coming in and communication source, or any other desired way, for example. In addition, the prioritized list may be delivered to the user in a method selected by the user. For example, the prioritized list of messages may be sent via e-mail, voice mail, or fax at predetermined intervals or during the occurrence of predetermined events, such as when a new communication is received at step 308 in process 300.

The CAP process is not limited to the process as shown in FIG. 3. For example, in some embodiments, the automatic response transmitted to the sender of a communication at step 314 also includes a prompt that queries the original sender to indicate if the expected response time determined at step 310 is not acceptable to the original sender. For example, if the original sender needs to communicate with the user sooner than the expected response time, the original sender may respond to the prompt requesting to be transferred to a designated person, i.e. assistant, colleague, etc., established by the user. Additionally, the CAP may include a track and follow up feature that tracks the automatic responses sent out by a person designated by the user. The track and follow allows a user to see a log of correspondences between the designated user and various senders. According to one embodiment, the history of correspondences associated with a communication is included with each communication 401, 402, 403 and 404 in prioritized communication list 400. According to one embodiment, when the user returns from a period of unavailability, the user may indicate so to CAP using I/O device 106. In response the CAP may optionally broadcast a message to all senders who received an automatic response that they have returned such as “I have returned to the office. I see that you corresponded with my designated assistant. Do you have everything that you need?” Furthermore, if the automatic response transmitted an expected response time of 10:00 A.M., the CAP can provide the user with a reminder to return a message by 10:00 A.M. In addition, if the CAP determines the user has not responded to the sender within the expected response time, the CAP may transmit an additional updated response with an updated expected response time.

The CAP may also include a feature for incoming communications from users that have a low rank or low priority determined at steps 304 and 306, respectively. In such cases, the CAP may send telephone calls directly to voice mail without the phone ringing, block text messages, or send email to a folder other than the inbox folder. In addition, communications from certain sources or contacts may be sent to designated junk mail folders outside of prioritized communication list 400 and permanently blocked at the discretion of the user. Furthermore, the CAP may compile a combined list of such low rank and low priority messages on a separate low priority communications list. Additionally, rather than a user setting a time frame of unavailability for all incoming communications, the user may pre-set certain time frames of unavailability for certain senders. For example, if the CAP detects the incoming communication is from a work related sender, the automatic response may indicate that the user is unavailable during non-business hours. In addition, the period of unavailability may be a reoccurring event stored in the CAP such that a user may indicate that every Monday from 9 A.M. to 10 A.M. is a period of unavailability.

In an embodiment, the CAP may include a functionality by which various functions of an associated computing device, such as a smartphone, may be disabled for a predetermined time period and/or in a predetermined location or physical area. According to such an embodiment, a user may select which functions to disable, the time period for which the computing device is to be disabled, a physical location in which the computing device is to be disabled, and/or the response to be provided to persons attempting to contact the user while the computing device is disabled. The location of the computing device may be determined based on GPS, cell tower triangulation, or any other location determination mechanism known to those of skill in the art. In addition, the computing device may be disabled when it is in motion which would help prevent texting while driving, etc. In an embodiment, the user may input such commands via the CAP on the specific computing device to be disabled. In an alternative embodiment, the user may input such commands via a website-based control on a website from which one or more computing devices may be selectively disabled or controlled. For example, a parent may selectively disable various functions of a phone (e.g., texting, calls, software applications, etc.) during a given time period or when the computing device is at a given location (e.g., at a school, church, etc.).

In another embodiment, the CAP may include a functionality by which a user may set a period of time or location for which the user is to be unavailable to certain contacts and/or available to others. According to such an embodiment, a user may select (via the CAP or via a website-based control) the period of time and indicate to which contacts the user is to be unavailable and/or to which contacts the user is to be available. The selection of the specific contacts may be based on a ranking of the contact, a characterization of the contact, on specific information from the profile of a contact, or on any other factor selected by the user. For example, the user may indicate that the user is to be unavailable to all “work” contacts after 5:00 p.m. In another example, the user may indicate that the user is to be available only to “family” contacts during a given time period. In still another example, the user may indicate that the user is to be unavailable to all contacts with a ranking of below a given threshold (e.g., a ranking of 5 out of 10).

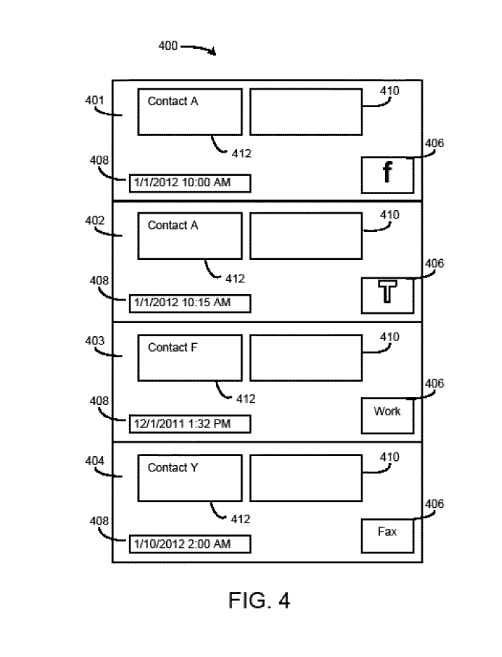

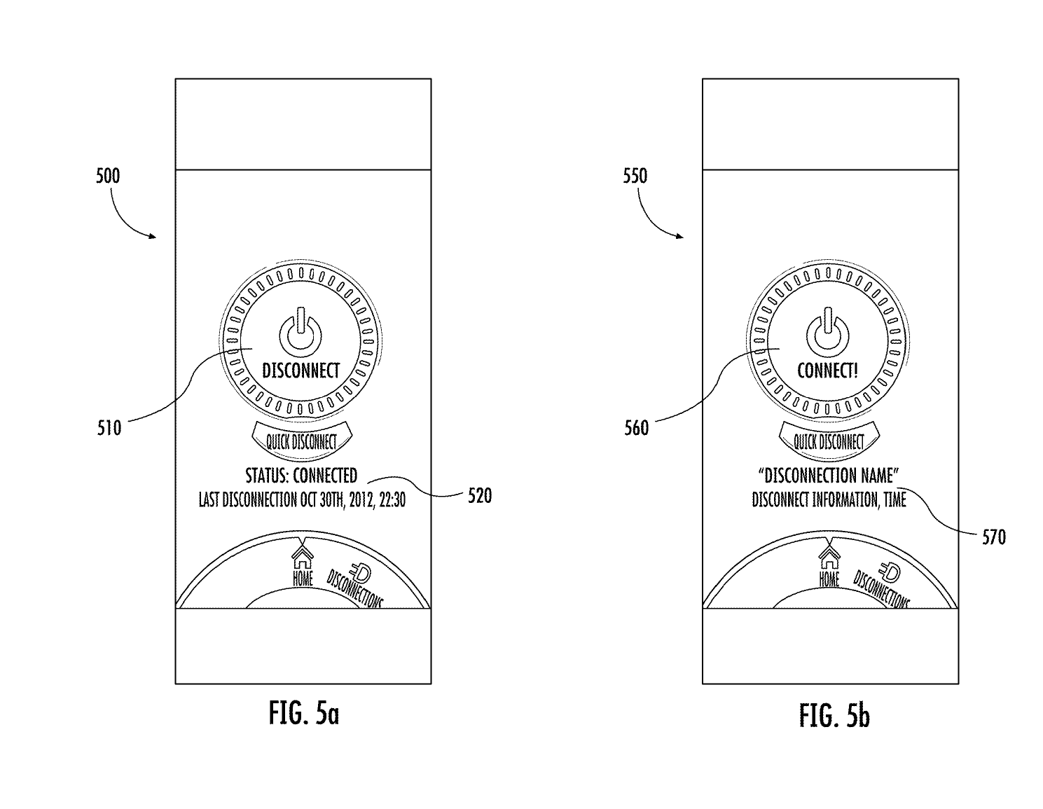

Furthermore, a user may set a time period of unavailability for any period of time which does not have to be predetermined and set up in advance. Rather, I/O 106 of client device 102 may receive an indication from a user that a period of unavailability is currently starting. According to such an embodiment, a user can initiate and discontinue the transmission of automatic responses with a simple click (e.g., a quick disconnect button) rather than through a graphical user interface being displayed on client device 102. FIG. 5a depicts a graphical user interface 500 having a quick disconnect button 510 in accordance with an illustrative embodiment. By selecting quick disconnect button 510, a user can quickly disconnect from predetermined communication methods and initiate the transmission of automatic responses (e.g., away messages) to predetermined contacts that attempt to communicate with the user through one of the predetermined communication methods during the disconnection period. Graphical user interface 500 also includes a status bar 520 which indicates a current status of the connection (e.g., connected or disconnected), a last disconnection or connection date and time, a title for the communication session, or any other desired information. FIG. 5b depicts a graphical user interface 550 having a quick connect button 560 in accordance with an illustrative embodiment. By selecting quick connect button 560, a user can quickly reconnect to disconnected communication methods and discontinue the transmission of automatic response to predetermined contacts that attempt to communicate with the user. Graphical user interface 550 also includes a status bar 570 which may indicate a current status of the connection (e.g., connected or disconnected), a last disconnection or connection date and time, a title for the communication session, or any other desired information.

In addition, aggregating contacts 200 into a single prioritized list and aggregating communications into a single prioritized list 400 provides an additional benefit that a user can broadcast messages, alerts, invitations, etc., to contacts contained in a variety communication formats and sources 110, 112, 126, 128, 130, 132, 134, 136, and 138. For example, a user will be able to send out a single event invitation to all aggregated contacts with a priority over 6, for example, regardless of whether the contact is a facebook friend, twitter follower, co-worker, according to one embodiment.

Additionally, the CAP may exhibit computer learning by examining previous expected response times transmitted at step 314 and comparing those expected response times with actual response times achieved by the user. If the comparison reveals a disparity above a predetermined threshold the CAP may automatically adjust the process used to determined an expected response time at step 310 or may also provide this information to the user at a later time so that the user can manually adjust processes executed in the CAP stored in memory module 172. In addition, the CAP may interface with other software programs stored on client device 102, for example. According to one embodiment, aggregate communication list 400 may transfer data to a text-to-speech program so that disabled user can receive audible data from speakers on client device 102 from communications received from a variety of formats. According to another embodiment, aggregate communication list 400 may transfer data to language conversion program so that communications in any language may be converted to any other language.

FIG. 6 depicts a graphical user interface 600 of a CAP in accordance with an illustrative embodiment. In an embodiment, graphical user interface 600 enables a user to set and selectively activate or deactivate disconnection periods. Graphical user interface 600 includes a disconnection period 610 entitled “My Family Time” and a disconnection period 620 entitled “Vacation.” Disconnection periods 610 and 620 indicate preset disconnection time periods for the user which may be selectively activated or deactivated. For example, when disconnection period 610 is activated, the user will be disconnected on Sundays, Tuesdays, and Saturdays between 8:30 and 15:20. When disconnection period 620 is activated, the user will be disconnected from Jul. 31, 2013 through Jul. 5, 2013 from 8:30 to 15:00 each day. As discussed previously and as discussed in more detail below, the user may select specific communication media and particular contacts or contact groups from which the user will be disconnected during these time periods. Thus, the user may effectively disconnect from specified groups or contacts during specified time periods while still being available to other groups or contacts during these specified time periods.

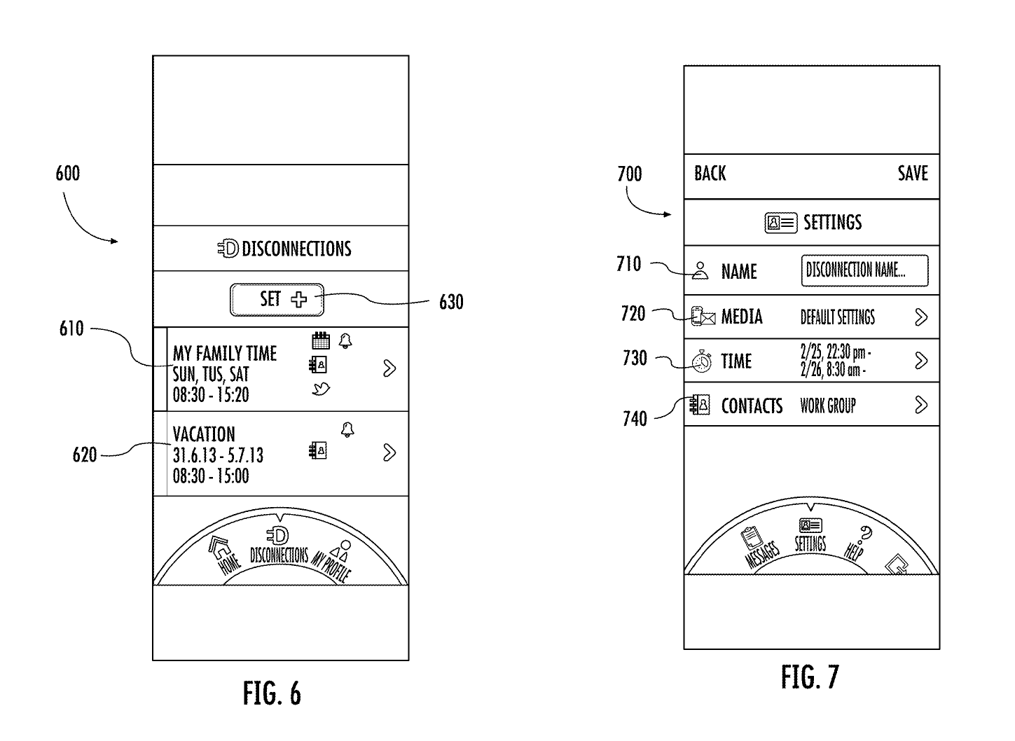

Graphical user interface 600 further includes a set button 630, which upon selection by the user enables the user to set additional disconnection periods. In an embodiment, upon selection of set button 630, the user will be presented with a settings interface. FIG. 7 depicts a settings interface 700 of a CAP in accordance with an illustrative embodiment. Settings interface 700 enables a user to set various parameters for a new disconnection period. Settings interface 700 includes a name field 710, a media field 720, a time field 730, and a contacts field 740. Name field 710 enables the user to input a name for the new disconnection period. Media field 720 enables the user to select specific communication media from which the user is to be disconnected during the new connection period. Time field 730 enables the user to set the specific dates and time periods for the new disconnection period, and contacts field 740 enables the user to select specific contacts, groups of contacts, or contact ranking thresholds to determine from which contacts the user will be disconnected during the new disconnection period.

In an embodiment, upon selection of media field 720, the user will be presented with a media selection interface. FIG. 8 depicts a media selection interface 800 of a CAP in accordance with an illustrative embodiment. Media selection interface 800 includes multiple selectable fields corresponding to respective types of communication media that may be selectively included in the disconnection mode. The multiple selectable fields include social media field 810, phone call field 820, short messaging service (SMS) field 830, email field 840, and program service field 850. In alternative embodiments, additional or fewer communication media types may be included as selectable fields. Upon selection of a respective selectable field, the corresponding communication media type will be included in the disconnect action during the new disconnection field. For example, if phone call field 820 and SMS field 830 are both selected, then during the new disconnection period the user will be prevented from receiving phone calls or SMS's and appropriate response messages will be automatically sent to the contacts attempting to communicate with the user via a phone call or SMS.

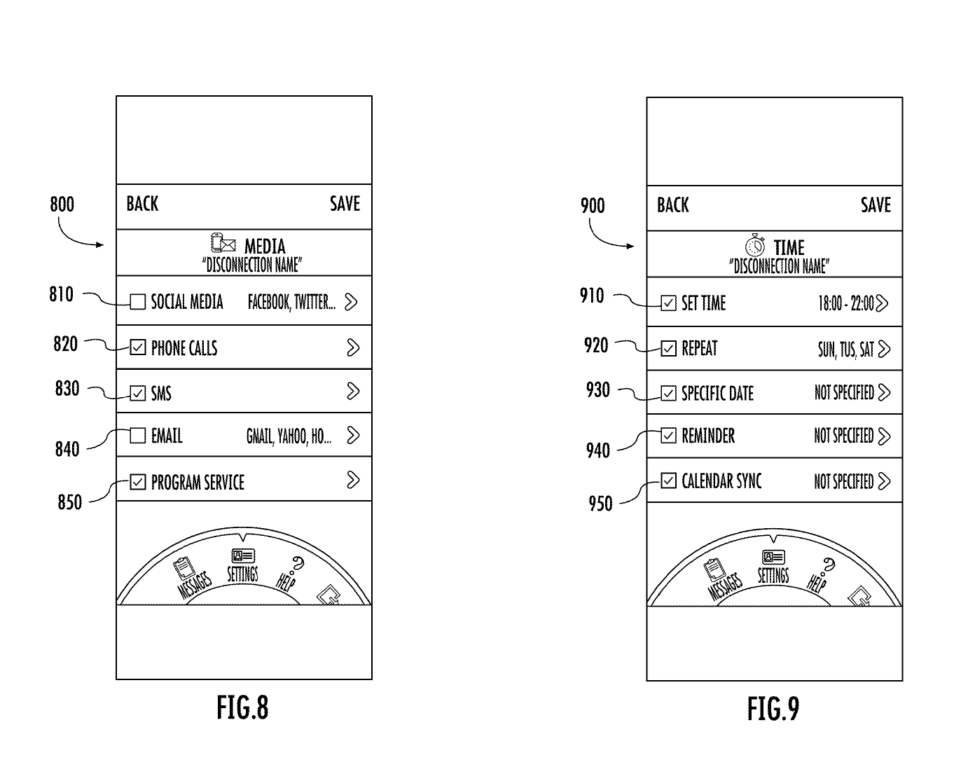

In an embodiment, upon selection of time field 730 from settings interface 700, the user will be presented with a time selection interface. FIG. 9 depicts a time selection interface 900 of a CAP in accordance with an illustrative embodiment. Time selection interface 900 includes a set time field 910, a repeat field 920, a specific date field 930, a reminder field 940, and a calendar sync field 950. Set time field 910 enables a user to set a specific time period for the new disconnection period. Repeat field 920 enables a user to select time intervals, days, or other periods of time over which the specific time period selected in set time field 910 will repeat. Specific date field 930 allows the user to select a specific date or date range for the new disconnection period. Reminder field 940 allows the user to set a reminder regarding the new disconnection period, and calendar sync field 950 allows the user to selectively sync a separate calendar with the time and data of the new disconnection period. In addition, the creation of a new appointment in the calendar may automatically create a corresponding disconnection time or may automatically prompt the user with the ability to set a corresponding disconnection time.

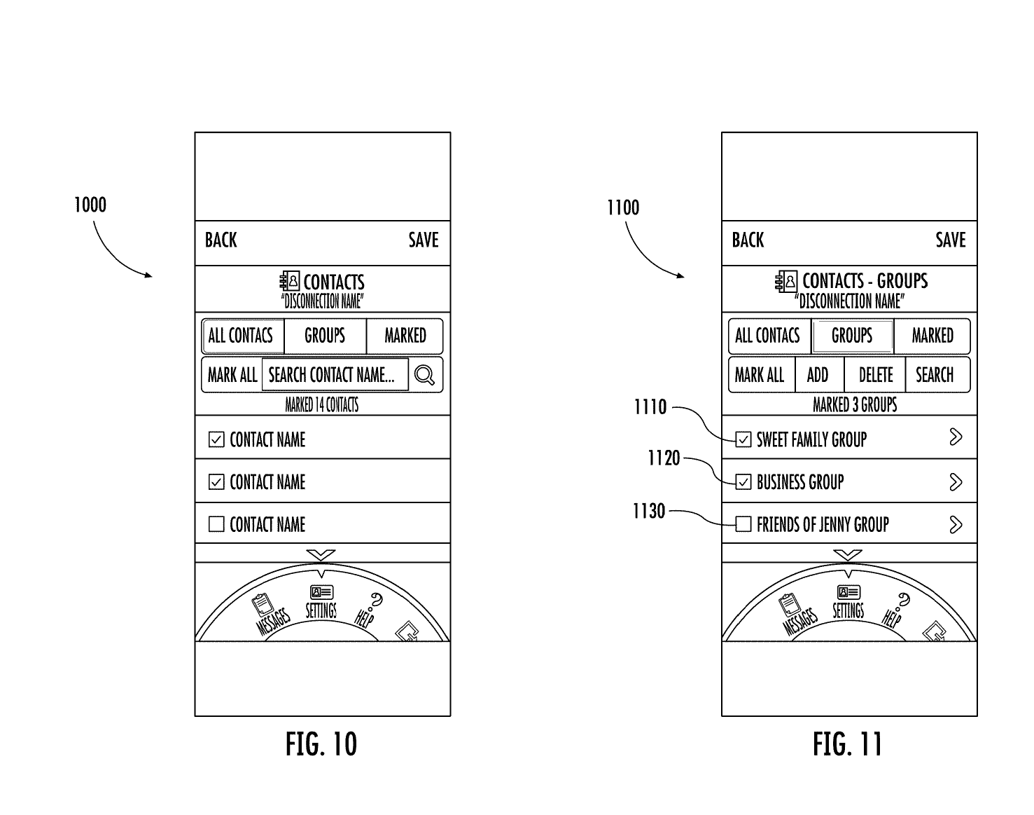

In an embodiment, upon selection of contacts field 740 from settings interface 700, the user will be presented with a contact selection interface. FIG. 10 depicts a contact selection interface 1000 of a CAP in accordance with an illustrative embodiment. Contact selection interface 1000 enables a user to select specific contacts or groups of contacts for which the new disconnection period is to be applied. The user may select specific individual contacts, all contacts, or specific predefined groups of contacts. FIG. 11 depicts a group contact selection interface 1100 of a CAP in accordance with an illustrative embodiment. For example, group contact selection interface 1100 includes a family group 1110, a business group 1120, and a friends group 1130. In alternative embodiments, group contact selection interface 1100 may include additional or fewer groups according to the preferences of the user.

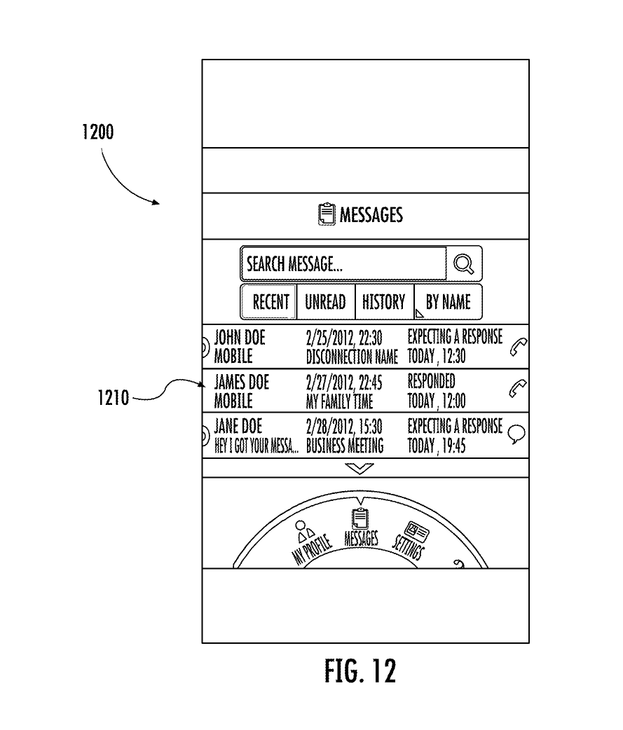

FIG. 12 depicts a message review interface 1200 of a CAP in accordance with an illustrative embodiment. Message review interface 1200 enables a user to review and/or respond to messages received from contacts during a disconnection period. According to the embodiment, message review interface 1200 may or may not be accessible to the user during a disconnection period. Message review interface 1200 may include one or more messages 1210. For each message 1210, message review interface 1200 may indicate the name of the contact, the time and date of the original message, an expected response time, the type of message, or any other desirable information. In an embodiment, message review interface 1200 may allow the user to sort the messages by most recent, unread vs. read, history, by name, or by any other possible criteria. In still another embodiment, a user may share message review interface 1200 with another person, such as a secretary or assistant.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus, such as a processing circuit. A processing circuit such as CPU 160 or 142 may comprise any digital and/or analog circuit components configured to perform the functions described herein, such as a microprocessor, microcontroller, application-specific integrated circuit, programmable logic, etc. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of aggregating and responding to communications, the method comprising:
receiving, at a computing device, incoming communications from a plurality of network connected communication sources;
determining, by the computing device, a customized message for each of the plurality of network connected communication sources based on at least identification information associated with a sender of the respective incoming communication; and
automatically sending from the computing device to each of the plurality of network connected communication sources the respective customized message, wherein the each respective customized message is based on a priority ranking of the sender of the respective incoming communication.

2. The method of claim 1, wherein the customized message includes an expected response time.

3. The method of claim 2, further comprising, upon expiration of the expected response time, automatically sending a second message to those network connected communication sources to which a response has not been sent within the expected response time.

4. The method of claim 2, wherein the expected response time is specific to a particular sender of an incoming communication.

5. The method of claim 2, further comprising sending a query to at least one of the plurality of network connected communication sources to determine if the expected response time is acceptable.

6. The method of claim 1, wherein the plurality of network connected communication sources comprises network connected communication sources having different formats.

7. The method of claim 6, wherein the plurality of network connected communication sources comprises at least two of a social media communication source, a telephone communication source, an email communication source, and a short messaging service communication source.

8. The method of claim 1, further comprising:
receiving rankings of a plurality of contacts from a user of the computing device; and
aggregating the plurality of contacts into a prioritized list based on the received rankings.

9. The method of claim 1, further comprising disabling one or more functions of an electronic device or the computing device for a predetermined time in response to a command from a user of the computing device.

10. The method of claim 9, wherein the one or more functions are disabled when the electronic device or the computing device are determined to be in motion.

11. The method of claim 1, wherein content of the customized message is based on a priority previously assigned to the sender of the respective incoming communication and a total number of incoming communications.

12. The method of claim 1, further comprising receiving a quick disconnect command from a user of the computing device, wherein the quick disconnect command indicates that the user is to be unavailable for indefinite amount of time.

13. The method of claim 12, wherein the user is to be unavailable to contacts of a first group but available to contacts of a second group.

14. The method of claim 1, further comprising automatically generating a disconnection period in response to receiving an input to create an appointment in an electronic calendar associated with the computing device.

15. The method of claim 1, further comprising broadcasting a message to the plurality of network connected communication sources, wherein the plurality of network connected communication sources comprise a variety of different communication formats.

16. A non-transitory computer-readable medium comprising computer-executable instructions that, upon execution by a computing device, cause the computing device to perform operations comprising:
receiving incoming communications from a plurality of network connected communication sources;
determining a customized message for each of the plurality of network connected communication sources based on at least identification information associated with a sender of the respective incoming communication; and
automatically sending from the computing device to each of the plurality of network connected communication sources the respective customized message, wherein the each respective customized message is based on a priority ranking of the sender of the respective incoming communication.

17. The non-transitory computer-readable medium of claim 16, wherein the customized response includes an expected response time.

18. The non-transitory computer-readable medium of claim 16, wherein the plurality of network connected communication sources comprises at least two of a social media communication source, a telephone communication source, an email communication source, and a short messaging service communication source.

19. The non-transitory computer-readable medium of claim 16, wherein the plurality of network connected communication sources comprises communication sources from at least two different forms of social media.

20. The non-transitory computer-readable medium of claim 16, wherein the computer-executable instructions, upon execution by the computing device, cause the computing device to perform operations further comprising:
receiving rankings of a plurality of contacts from a user of the computing device; and
aggregating the plurality of contacts into a prioritized list based on the received rankings.

21. The non-transitory computer-readable medium of claim 16, wherein the computer-executable instructions, upon execution by the computing device, cause the computing device to perform operations further comprising disabling one or more functions of an electronic device or the computing device for a predetermined time in response to a command from a user of the computing device.

22. A device comprising:
a memory configured to store a communication aggregation program;
a processor connected to the memory and configured to execute the communication aggregation program to:
receive incoming communications from a plurality of network connected communication sources;
determine a customized message for each of the plurality of network connected communication sources based on at least identification information associated with a sender of the respective incoming communication; and
automatically send to each of the plurality of network connected communication sources the respective customized message, wherein the each respective customized message is based on a priority ranking of the sender of the respective incoming communication.

23. The device of claim 22, wherein the processor is further configured to disable one or more functions of an electronic device for a predetermined period of time in response to a command from a user of the device.

24. The device of claim 22, wherein the processor is further configured to disable one or more functions of an electronic device in response to the electronic device being located at a predetermined location or within a predetermined area.
